(19) United States
(12) Patent Application Publication
(10) Pub. No.: US 2002/0195971 A1
(43) Pub. Date: Dec. 26, 2002

(54) High efficiency driver apparatus for driving a cold cathode fluorescent lamp

(75) Inventors: Jinrong Qian, Croton-on-Hudson (CN); DaFeng Weng, San Jose, CA (US)

Correspondence Address: CORPORATE PATENT COUNSEL, U.S. PHILIPS CORPORATION, 580 White Plains Road, Tarrytown, NY, 10591, US

(73) Assignee: Philips Electronics North America Corporation

(21) Appl. No.: 09/883,445

(22) Filed: Jun. 18, 2001

(51) Int. Cl. H05B 37/02

(52) U.S. Cl. 315/224; 315/276

(57) ABSTRACT

An inverter circuit for a gas discharge lamp having a primary circuit having a DC voltage supply, a transformer, a switching circuit including a first switch and a second switch for controlling a conduction state of the inverter circuit; a tank circuit having a resonant inductor and a resonant capacitor, the lamp load being coupled with the resonant capacitor; and a capacitor coupled to the first and second switches for maintaining a voltage across a primary winding of said transformer. Accordingly, the required turns ratio of the transformer is reduced by half which reduces the power loss in the transformer, thereby improving circuit efficiency. In addition, energy stored in a leakage inductance, which is otherwise dissipated across the switches of the push-pull switch configuration in the prior art, is recovered or captured by the clamping capacitor, thereby preventing the occurrence of voltage spikes across the switches.

### BACKGROUND OF THE INVENTION

1. Field of the Invention

The present invention relates to a device for driving a cold cathode fluorescent lamp (CCFL) used as a backlight of a liquid crystal display.

2. Description of the Related Art

Similar to a conventional hot-cathode fluorescent lamp (“FL”) used for office and home lighting, CCFLs are high-efficiency, long-life light sources. By comparison, incandescent lamps have efficiency in the range of 15 to 25 lumens per watt, while both FLs and CCFLs have efficiency in the range of 40 to 60 lumens per watt. Furthermore, the average life of an incandescent lamp is only about 1,000 hours. However, FLs and CCFLs, on average, last for 10,000 hours or more.

The main difference between a hot-cathode FL and a CCFL is that the CCFL omits filaments that are included in a FL. Due to their simpler mechanical construction and high efficiency, miniature CCFLs are generally used as a source of back lighting for Liquid Crystal Displays (“LCDs”). LCDs, whether color or monochrome, are widely used as displays in portable computers and televisions, and in instrument panels of airplanes and automobiles.

However, starting and operating a CCFL requires a high alternating current (“ac”) voltage. Typical starting voltage is around 1,000 volts AC (“Vac”), and typical operating voltage is about 600 Vac. To generate such a high ac voltage from a dc power source such as a rechargeable battery, portable computers and televisions, and instrument panels, include a dc-to-ac inverter having a step-up transformer.

In the push-pull configuration illustrated in FIG. 1, Lₖ₁ and Lk2 are the leakage inductances of the transformer T, Ds1 and Cₛ₁ are the body diode and internal capacitance of switch S1, respectively, and Dₛ₂ and Cₛ₂ are the respective body diode and internal capacitance of switch S2. Winding N3 is coupled with windings N1 and N2. Inductor Lr, is a resonant inductor including a leakage inductance of transformer T. Inductor Lr and capacitor Cr form a resonant tank to provide a high frequency voltage to the load, Rₒ.

FIGS. 2a-2d illustrate typical switching waveforms associated with the circuit of FIG. 1. Referring first to FIG. 2a, at the point in time when switch S1 is turned off (t0) energy stored in the leakage inductance Lₖ₁ is released to charge the capacitance Cs1 which causes an undesirable voltage spike across switch S1, as illustrated in FIG. 2c. Another problem associated with the circuit configuration of FIG. 1 is that the high voltage spike requires that switches S1 and S2 have high voltage breakdown voltage ratings.

At time t1, the gate signal (See FIG. 2b) of switch S2 is applied allowing switch S2 to be turned on at zero voltage (not shown). S2 carries the primary winding current.

As shown in FIG. 2d, a second voltage spike occurs at time t2 at switch S2, the point at which switch S2 is turned off. This voltage spike is the result of the release of energy from the leakage inductance Lₖ₂.

Referring now to FIG. 3, one prior art solution for eliminating or minimizing the undesirable voltage spikes is through the use of passive snubber circuits (R-C-D) for switch S1 and (R-C-D) for switch S2, respectively. The passive snubber circuits are designed to absorb the leakage energy of the transformer (Lₖ₁, Lₖ₂). An undesirable consequence of using snubber circuits is that the converter circuit has a lower conversion efficiency by virtue of having to dissipate the undesirable leakage energies.

Another type of conventional ballast, illustrated in FIG. 4, employs a half-bridge inverter circuit configuration. The half-bridge switching circuit includes switches S1 and S2, resonant inductor Lᵣ and resonant capacitor Cᵣ. Inductor Lᵣ could represent the leakage inductance or a separate inductance in the case where the leakage inductance is insignificant. Cᵣ could represent a combination of the winding capacitance and shield capacitance of the lamp. C_{d} represents a DC blocking capacitor. The input voltage, Vᵢₙ, is typically around 12V. Until the CCFL or load (R_{L}) is “struck” or ignited, the lamp will not conduct a current with an applied terminal voltage that is less than the strike voltage, e.g., the terminal voltage can be as large as 1000 Volts. Once an electrical arc is struck inside the CCFL, the terminal voltage may fall to a run voltage that is approximately ⅓ the value of the strike voltage over a relatively wide range of input currents. To achieve voltages on the order of 1000 volts, a high voltage gain of the resonant inverter is required in addition to a high turns ratio of the isolation transformer. However, given that the peak excitation voltage Vₓ of the resonant tank is only one-half the input voltage, the resonant inverter voltage gain is restricted. Therefore, the only means of achieving a strike voltage on the order of 1000 volts is to require that the transformer have a very high turns ratio. This is problematic, however, in that a high turns ratio transformer is characteristically leaky and therefore not efficient.

Accordingly, it is desirable to provide an improved ballast which is more efficient in operation than a conventional ballast whether of the push-pull or half-bridge type while reducing or substantially eliminating spike voltages.

### SUMMARY OF THE INVENTION

Accordingly, it is an object of the invention to provide an inverter circuit which eliminates or substantially reduces voltage spikes associated with switching elements in a push-pull switch configuration.

It is a further object of the invention to provide an inverter circuit which recovers leakage energy associated with an isolation transformer to improve circuit efficiency.

It is yet a further object of the invention to provide an inverter circuit which reduces the turns ratio of the isolation transformer to reduce power losses in the transformer to further improve circuit efficiency.

In accordance with an embodiment of the present invention, there is provided an inverter circuit and a method for efficiently converting a direct current (DC) signal into an alternating current (AC) signal for driving a load such as a cold cathode fluorescent lamp. The inverter circuit includes a resonant tank circuit having a resonant inductor and resonant capacitor and coupled via a transformer between a DC signal source and a common terminal of a half-bridge switch configuration. A voltage clamping capacitor is connected to a second and third terminal of the half-bridge switch configuration. A voltage difference between the capacitor voltage and the supply (i.e., input) voltage is applied to the terminals of the resonant tank. The voltage difference across the resonant tank is nominally twice the voltage of prior art configurations.

The inverter circuit according to the present invention includes a primary circuit having a DC voltage supply, a transformer coupling said primary and load circuits, a switching circuit comprising a first switch and a second switch for controlling a conduction state of said inverter circuit; a tank circuit having a resonant inductor and a resonant capacitor, the lamp load being coupled with the resonant capacitor; and a capacitor coupled to the first and second switches for maintaining a voltage across a primary winding of said transformer.

Accordingly, the required turns ratio of the transformer is reduced by half, as compared to prior art inverter circuits, thereby reducing the power loss in the transformer which improves circuit efficiency.

In accordance with another aspect of the present invention, the leakage energy stored in a leakage inductance associated with the transformer is recovered or captured by the clamping capacitor thereby preventing or substantially reducing the occurrence of voltage spikes across the switches which comprise the half-bridge switching configuration. As described above, in one prior art configuration, this leakage inductance, when released, charges a capacitance associated with the push-pull switches which causes voltage spikes across the switches. An additional advantage of capturing the leakage current is that the voltage ratings of the switches is significantly reduced.

### BRIEF DESCRIPTION OF THE DRAWINGS

The foregoing features of the present invention will become more readily apparent and may be understood by referring to the following detailed description of an illustrative embodiment of the present invention, taken in conjunction with the accompanying drawings, where:

FIG. 1 is a circuit diagram illustrating an LCD backlighting inverter circuit of the prior art;

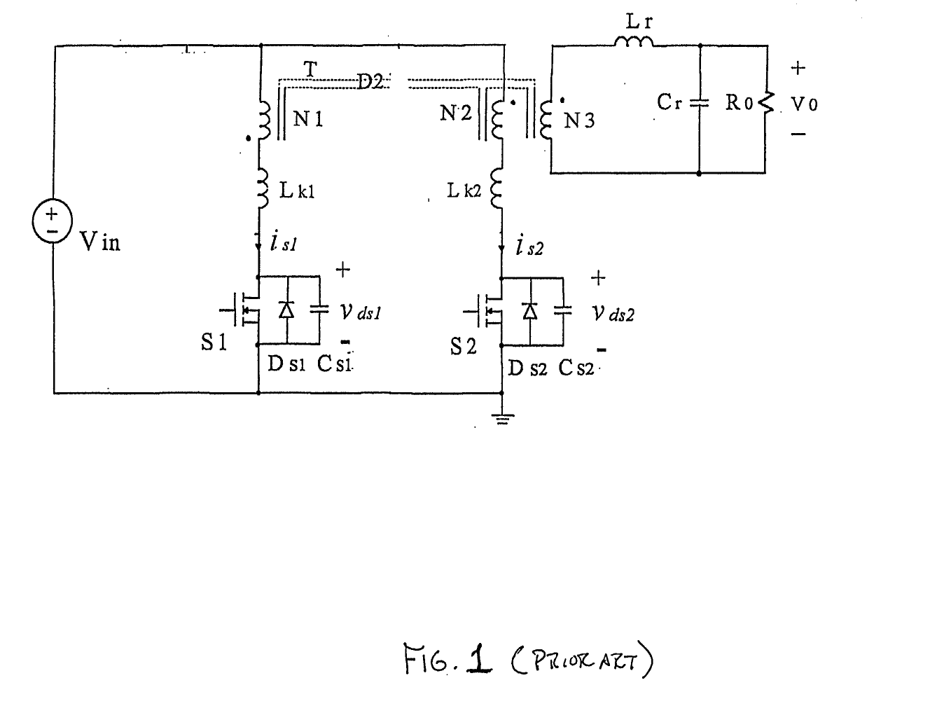

FIGS. 2a-2d illustrate representative waveforms present in the circuit of FIG. 1;

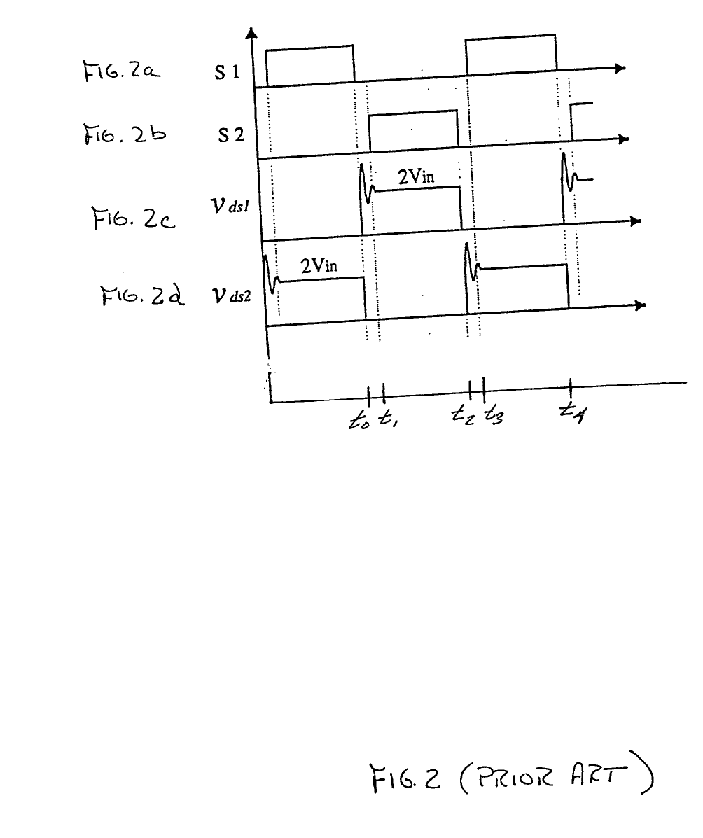

FIG. 3 is a circuit diagram illustrating an LCD backlighting inverter circuit of the prior art;

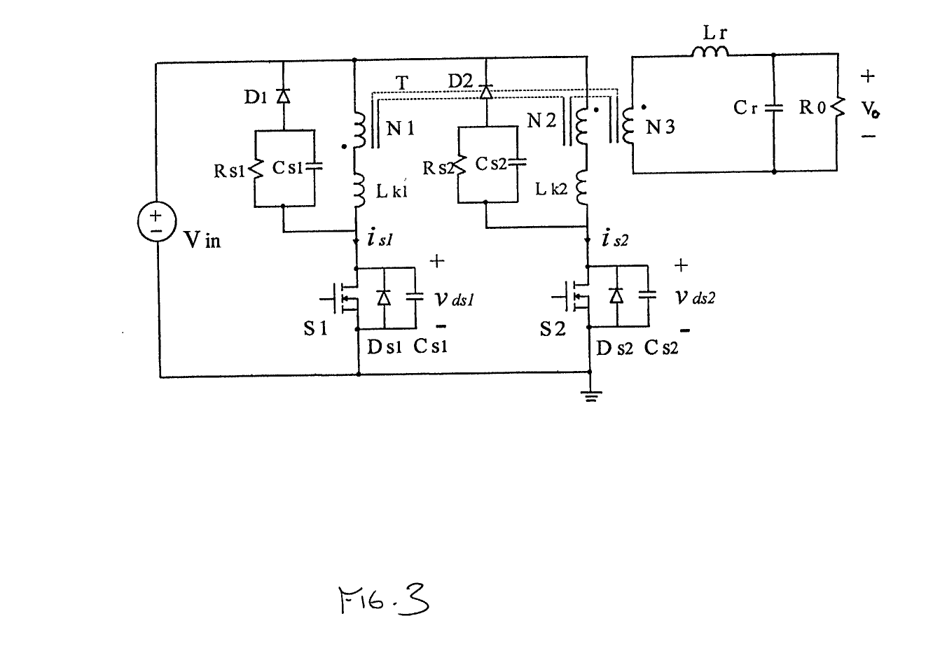

FIG. 4 is a circuit diagram illustrating an LCD backlighting inverter circuit of the prior art;

FIG. 5 is a circuit diagram illustrating an LCD backlighting inverter circuit in accordance with an embodiment of the present invention;

FIGS. 6a-6d illustrate representative waveforms present in the circuit of FIG. 5;

FIG. 7 is a circuit diagram illustrating an LCD backlighting inverter circuit in accordance with an embodiment of the present invention;

FIG. 8 is a circuit diagram illustrating an LCD backlighting inverter circuit in accordance with an embodiment of the present invention; and

FIG. 9 is a circuit diagram illustrating an LCD backlighting inverter circuit in accordance with an embodiment of the present invention.

### DESCRIPTION OF THE PREFERRED EMBODIMENTS

A circuit configuration is provided to obviate voltage spikes which occur at turn-off for each push-pull switch of an inverter circuit. Additionally, the circuit configuration is more efficient than conventional inverter circuit configurations.

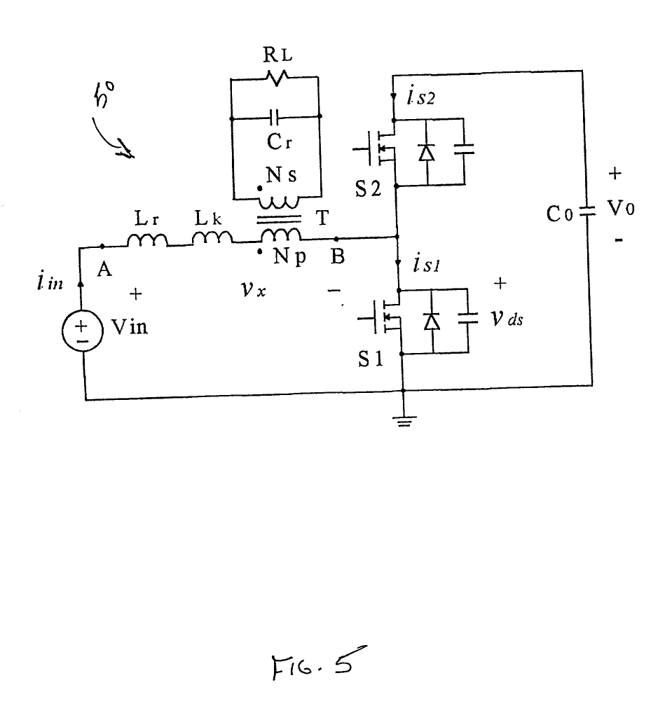

Turning now to FIG. 5, an exemplary schematic of the inverter circuit 10 displays one embodiment of the inventive circuit configuration connected to a load R_{L}. Load R_{L} can be, but is not limited to a fluorescent lamp of the cold cathode type. The light from load R_{L} can be used to illuminate a liquid crystal display (LCD) of a computer. Load R_{L} is connected to a secondary winding of a transformer T. Transformer T includes one primary winding, Nₚ, and one secondary winding Nₛ. A resonant circuit is formed by a resonant inductor Lr and a resonant capacitor Cr. Other than resonant inductor Lr and resonant capacitor Cr, there is no other discrete inductor or capacitor included which substantially affects the resonant frequency of the resonant circuit. There is also no discrete ballasting element, typically a capacitor, in series with load R_{L}. The elimination of these discrete components from the resonant circuit or serially connected to the load R_{L} reduces the parts count and cost of the inverter circuit 10.

The half-bridge switching circuit (i.e., switching stage) includes switches S1 and S2. These switches are turned on and off by a drive control circuit (not shown). Switches S1 and S2 are never turned on at the same time and have ON time duty ratios of slightly less than 50% as shown in FIG. 5. A small dead time during which both switches are turned off is required to permit the zero voltage switching to be implemented. An output of the primary winding Nₚ of the transformer T is connected to a midpoint connection terminal of the half-bridge switching circuit (See point B in FIG. 5). A clamping capacitor C₀ is connected in parallel with the half-bridge switching circuit. The inverter circuit 10 is sourced by a 12 V DC power supply, i.e., a battery, connected to one side of a resonant inductor Lr.

The circuit arrangement shown in FIG. 5 operates as follows. When switch S1 turns on during a first half-switching cycle (S1 on/S2 off), the input voltage Vᵢₙ is applied to terminals A and B of a resonant tank. That is, Vₓ=Vᵢₙ. During this first half switching cycle, inductor Lr stores energy to be released in the next (i.e., second) half switching cycle (S1 off/S2 on).

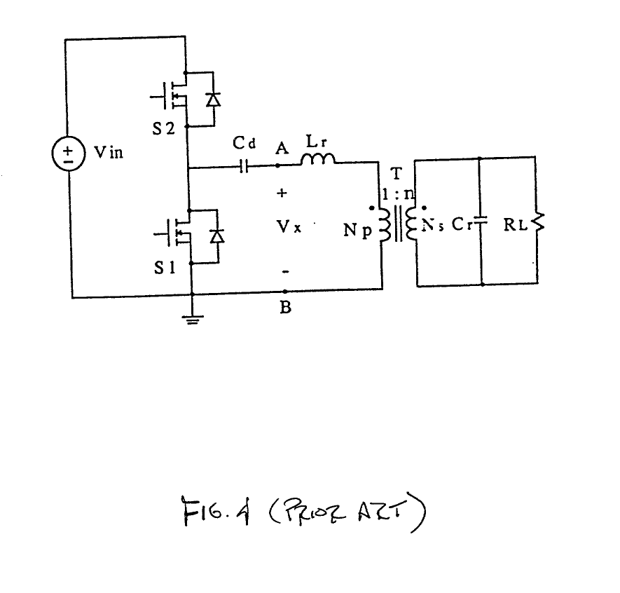

During the second half switching cycle (S1 off/S2 on). The voltage difference between the input voltage, Vᵢₙ, and capacitor voltage, Vₒ, is applied to the terminals A and B of the resonant tank. It will be shown that the capacitor voltage, equals nominally twice the input voltage, (2*Vᵢₙ), during the second half switching cycle assuming a duty ratio of nominally 0.5 for the half-bridge switch configuration. In accordance with standard circuit analysis, it is shown that a voltage (−Vᵢₙ) is applied to terminals A and B of the resonant tank during the second half switching cycle. In sum, the voltage across the resonant tank 50, i.e., terminals A and B, during the respective half-cycles equals Vin and −Vin, respectively. This is in contrast to the prior art circuits of FIG. 4 in which the voltage across the resonant tank 50 is ½*Vᵢₙ to −½*Vᵢₙ, respectively.

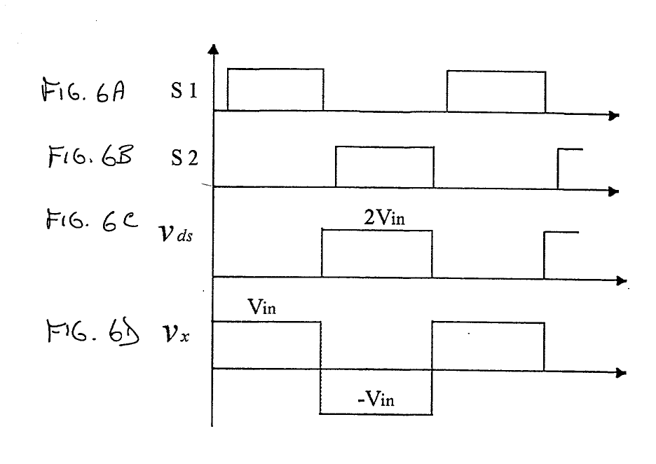

FIGS. 6a-6d illustrate typical switching waveforms associated with the inverter circuit 10 of FIG. 6. Referring first to FIGS. 6a and 6d, as stated above, for a first-half switching cycle (S1 on/S2 off), the voltage across the resonant tank 50, Vₓ, equals Vᵢₙ, (See FIG. 6d).

It is well known in the art that for proper steady state operation, the average voltage across the terminals A and B of the resonant tank 50 must be near zero, otherwise the resonant inductor Lᵣ and transformer T will saturate. Given that the average value of Vₓ must be a zero or near zero value, the average value of V_{ds}, the body diode voltage of switch S1, must equal the average value of Vᵢₙ. During the second half switching cycle (S1 off/S2 on), V_{ds} reaches a peak value of 2*Vᵢₙ, as shown in FIG. 6c. This peak voltage is realized in part to the circuit being configured to provide a boost function. Specifically, a portion of the energy stored in inductor Lr during the first half switching cycle is released during the second half switching cycle. This released energy is captured and maintained by clamping capacitor Co. The voltage on Co is further supplemented by the input voltage Vin to achieve the peak value 2*Vᵢₙ during the second half switching cycle. It is noted that the capacitance value chosen for clamping capacitor Co is such that the peak voltage is maintained over multiple cycles.

Given that the average voltage across Vₓ must be zero or near zero over a full cycle and recalling that Vₓ=Vᵢₙ for the first half-cycle, Vₓ must therefore equal (−Vᵢₙ) the second half cycle to maintain a zero or near zero value over a full cycle. During the second half-switching cycle (i.e., S2 on/S1 off) the circuit voltages of the inverter circuit 10 can be stated as:

Vᵢₙ=Vₓ+V₀ Eq. 1

which can be re-written as:

Vₓ=Vᵢₙ−V₀ Eq. 2

Equation (2) states that the tank excitation voltage, Vₓ, is the difference between the input voltage, Vᵢₙ, and the clamping capacitor voltage. As described above, during this second half-cycle the capacitor voltage can be stated as

V₀=2*V Eq. 3

Substituting Eq. (3) into Eq. (2) yields:

$$\begin{matrix}{V}_{x} = {V}_{i n} - ( 2 * {V}_{i n} ) \\ = - {V}_{i n}\end{matrix} \qquad \text{Eq. 4}$$

Voltage Vₓ for the second half cycle is illustrated in FIG. 6d.

It is appreciated that the average tank excitation voltage of the inventive circuit is twice that of the prior art circuit of FIG. 4. As a result, the required turns ratio of the transformer T is reduced by half. Correspondingly, the leakage inductance is significantly reduced thereby improving the overall efficiency of the circuit. In addition, the maximum voltage across the half-bridge switches is clamped by the capacitor voltage, Vo, and given as:

Vo=Vᵢₙ/(1−D) Eq.5

where D is the duty ratio of switch S1, which is nominally 0.5. A further advantage of circuit 10 is that unlike the prior art circuits where the leakage inductance is dissipated by a snubber network contributing to circuit inefficiency, the circuit 10 of the present invention recovers the leakage energy by utilizing a boost feature.

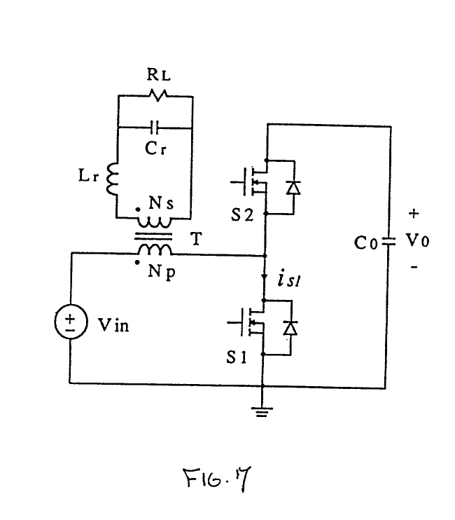

FIGS. 7-9 illustrate additional embodiments of the inventive circuit 10 in which the illustrated components have the same reference symbols as those in FIG. 6.

In FIG. 7, one embodiment of the inventive circuit 10 is shown in which the resonant inductor Lᵣ is shown in series with the resonant capacitor Cᵣ while the load is in parallel with the resonant capacitor.

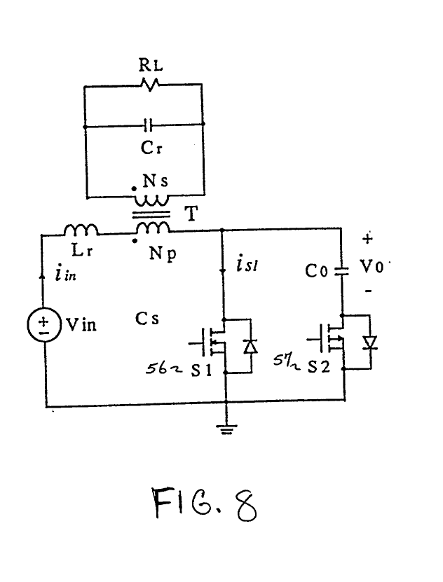

FIG. 8 shows another embodiment of the inventive circuit 10. In this embodiment, switch S2 is a P-type MOSFET and further connected to the negative terminal of clamping capacitor C₀.

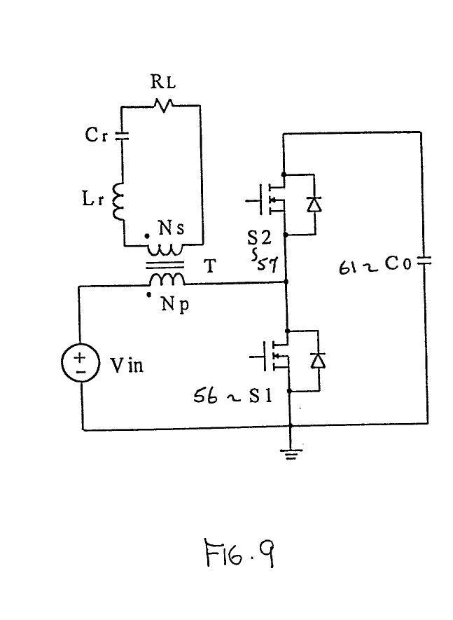

FIG. 9 shows another embodiment of the inventive circuit 10. In this embodiment, the resonant inductor Lᵣ is shown in series with the resonant capacitor Cᵣ in the load circuit.

In sum, the inventive circuit configuration provides advantages which are not achievable with the prior art circuit configurations discussed above. A first advantage realized by the inventive circuit is a higher efficiency due in part to the leakage inductance being a part of the resonant inductance. Specifically, the leakage inductance energy is fully recovered by virtue of being a part of the resonant inductance thereby precluding the need for a snubber circuit as used in the prior art. A second associated advantage is that the voltage across the half-bridge switches is reduced because of the energy recovery. As a consequence of the low turns ratio, the associated leakage inductance is minimized. A third associated advantage is that in addition to the leakage energy being recoverable it is also reduced as a consequence of the transformer having a lower turns ratio (i.e., one-half the conventional turns ratio). The lower turns ratio is achievable because the inventive circuit tank excitation voltage is twice that of a conventional excitation voltage.

We claim:

1. An inverter circuit for driving a gas discharge lamp load in a load circuit, the inverter circuit comprising:
a primary circuit having a DC voltage supply, a transformer coupling said primary circuit to said load circuit, a switching circuit comprising a first switch and a second switch for controlling a conduction state of said inverter circuit;
a tank circuit having a resonant inductor and a resonant capacitor, the lamp load being coupled to the resonant capacitor; and
a capacitor coupled to the first and second switches for maintaining a voltage across a primary winding of said transformer.

2. An inverter circuit according to claim 1, wherein the primary circuit includes the resonant inductor.

3. An inverter circuit according to claim 1, wherein the load circuit includes the resonant inductor.

4. An inverter circuit according to claim 1, wherein the lamp load is coupled in parallel with said resonant capacitor.

5. An inverter circuit according to claim 1, wherein the lamp load is coupled in series with said resonant capacitor and said resonant inductor.

6. An inverter circuit according to claim 1, wherein the resonant inductor is coupled in series with said primary winding of the transformer.

7. An inverter circuit according to claim 1, wherein the resonant inductor is coupled in series with a secondary winding of the transformer.

8. An inverter circuit according to claim 1, wherein the primary circuit includes the capacitor.

9. An inverter circuit according to claim 1, wherein the resonant inductor provides a boost function to said capacitor.

10. A method for eliminating voltage spikes in an inverter circuit for a gas discharge lamp comprising:
providing a primary circuit having a DC voltage supply, a transformer, a switching circuit having a first switch and a second switch for controlling a conduction state of said inverter circuit; and
providing a tank circuit having a resonant inductor and a resonant capacitor, the lamp load being coupled with the resonant capacitor; and
providing a capacitor coupled to the first and second switches for maintaining a voltage across a primary winding of said transformer.

11. The method of claim 10, further comprising the step of recovering leakage energy from said transformer in each of a plurality of switching cycles of said inverter circuit.

12. The method of claim 10, further comprising the step of providing a boost function by said resonant inductor to said capacitor.
